(19) United States
(12) Patent Application Publication
(10) Pub. No.: US 2025/0117796 A1
(43) Pub. Date: Apr. 10, 2025

(54) SYSTEMS AND METHODS FOR AUTOMATED RISK ASSESSMENT ANALYSIS

(71) Applicant: The PNC Financial Services Group, Inc., Pittsburgh, PA (US)

(72) Inventors: William Todd SIMMONS, New Kensington, PA (US); Navin Prabhakar Musalgavkar, McDonald, PA (US); Bradley Thomas HUNTER, Jacksonville, FL (US); Robert Joseph GRATTON, Pittsburgh, PA (US)

(73) Assignee: The PNC Financial Services Group, Inc., Pittsburgh, PA (US)

(21) Appl. No.: 18/984,771

(22) Filed: Dec. 17, 2024

Related U.S. Application Data
(63) Continuation of application No. 18/631,998, filed on Apr. 10, 2024.
Application No. 18/631,998 is a continuation of application No. 18/477,883, filed on Sep. 29, 2023, now abandoned.
(60) Provisional application No. 63/461,149, filed on Apr. 21, 2023.

(51) Int. Cl. H04L 9/40

(52) U.S. Cl. CPC G06Q 20/4014; H04L 63/0838; H04L 2463/082

(57) ABSTRACT

A computer-implemented method for performing a Know Your Client (KYC) process. The method includes receiving, at a processor, a request for initiating the KYC process. The method further includes sending a web link to for collecting KYC information, authenticating an identity via the web link, providing a KYC form via a web interface, and receiving the KYC information via the web interface.

### CROSS REFERENCE TO RELATED APPLICATION

This application claims the benefit of priority to U.S. Provisional Patent Application No. 63/461,149, filed Apr. 21, 2023, the entire contents of which are incorporated by reference.

### TECHNICAL FIELD

The present disclosure relates generally to systems and methods for Know Your Customer (KYC) processing. More specifically, and without limitation, this disclosure relates to automatically processing and storing the KYC information.

### BACKGROUND

Know Your Customer (KYC) is a process for financial institutions to ensure their customers are real and to assess and monitor risks of financial dealings. The KYC process usually involves collecting customer information such as name, address, date of birth, and government-issued ID number for an individual customer, or identity information of beneficial owner(s) or a control person for a business customer. Currently the KYC process requires customers manually providing forms with filled in information to the financial institutions, which often includes incomplete or inaccurate information and results in high volumes of rework to complete the KYC process.

Some other existing problems with the current KYC process include the following. It is time consuming and error prone to manually enter the KYC information to a customer database. The current KYC process also requires manually generating communication correspondences to customers to request KYC information from the customers, which is cumbersome for initiating the KYC information collection. In addition, customers are required to fill in the KYC forms and manually return the forms to the financial institution, which is a multi-step process requiring time and efforts from the customers.

The present solution overcomes these issues with manual forms by having users fill in a graphical user interface that allows customers to add and edit data using a digital solution. This data is then compared against existing data to verify information. Therefore, the present solution overcomes the existing issues with KYC systems and provides improved systems and methods for obtaining and processing KYC information.

### SUMMARY

In view of the foregoing, embodiments of the present disclosure provide computer-implemented systems and methods for performing a Know Your Customer (KYC) process. For example, in various exemplary embodiments, a system for performing a KYC process includes a memory storing a set of instructions; and at least one processor configured to execute the instructions to: receive a request for initiating a Know Your Client (KYC) process associated with a customer; send a web link to the customer for collecting KYC information associated with the customer; authenticate an identity of the customer via the web link; provide a KYC form to the customer via a web interface; and receive the KYC information via the web interface.

Embodiments in accordance with this disclosure include a computer-implemented method for performing a Know Your Customer (KYC) process. For example, in exemplary embodiments, a method may include receiving, at a processor, a request for initiating the KYC process, the KYC process being associated with a customer; sending a web link to the customer for collecting KYC information associated with the customer; authenticating an identity of the customer via the web link; providing a KYC form to the customer via a web interface; and receiving the KYC information via the web interface.

According to some embodiments, the KYC information may include at least one of a name, address, or an identification number.

According to some embodiments, authenticating the identity of a customer may comprise a multi-factor authentication process, wherein the multi-factor authentication process includes providing a one-time password.

According to some embodiments, the operations may further comprise providing auto-completed information in the KYC form.

According to some embodiments, the operations may further comprise retrieving information from one or more databases for the KYC form.

According to some embodiments, the operations may further comprise determining whether at least one piece of the KYC information is the same as KYC information of another entry.

According to some embodiments, the operations may further comprise providing a notification of the KYC information to a user.

According to some embodiments, the operations may further comprise determining that no KYC information is present in a database and adding the KYC information to the database.

According to some embodiments, the operations may further comprise determining whether the KYC information matches information in a database and providing a notification to a user if at least one price of the KYC information does not match information in the database.

According to some embodiments, the operations may further comprise sending an email providing the web link.

It is to be understood that the foregoing general description and the following detailed description are exemplary and explanatory only, and are not restrictive of the disclosed embodiments.

### BRIEF DESCRIPTION OF DRAWINGS

The accompanying drawings, which comprise a part of this specification, illustrate several embodiments and, together with the description, serve to explain the principles and features of the disclosed embodiments. In the drawings:

FIG. 1 illustrates an exemplary application of a KYC process, consistent with disclosed embodiments.

FIG. 2 illustrates an example environment for performing KYC validation, consistent with the disclosed embodiments.

FIG. 3 illustrates an example flow diagram for KYC processing, consistent with the disclosed embodiments.

FIG. 4 is a diagram of an exemplary system for performing a KYC process, consistent with disclosed embodiments.

FIG. 5 is a block diagram showing an example computing device, consistent with disclosed embodiments.

FIG. 6 is a flowchart of an exemplary method for performing a KYC process, consistent with disclosed embodiments.

FIG. 7 is a flowchart of an exemplary method for providing a KYC form, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added or steps may be removed without departing from the envisioned embodiments. Thus, the materials, methods, and examples are illustrative only and are not intended to be limiting.

Disclosed embodiments provide systems and methods for performing a Know Your Client (KYC) process for a customer. Upon receiving a request for initiating a KYC process with a customer, the system provides a web link for the customer to complete the KYC information. The system may authenticate an identity of the customer via the web link. If the customer is authenticated, the system may provide a KYC form via a web interface and receive the KYC information from the customer via the web interface. The system may transform the received KYC information into a particular format and store it in a customer database. Thus, the KYC information is collected and stored in the system with less manual intervention.

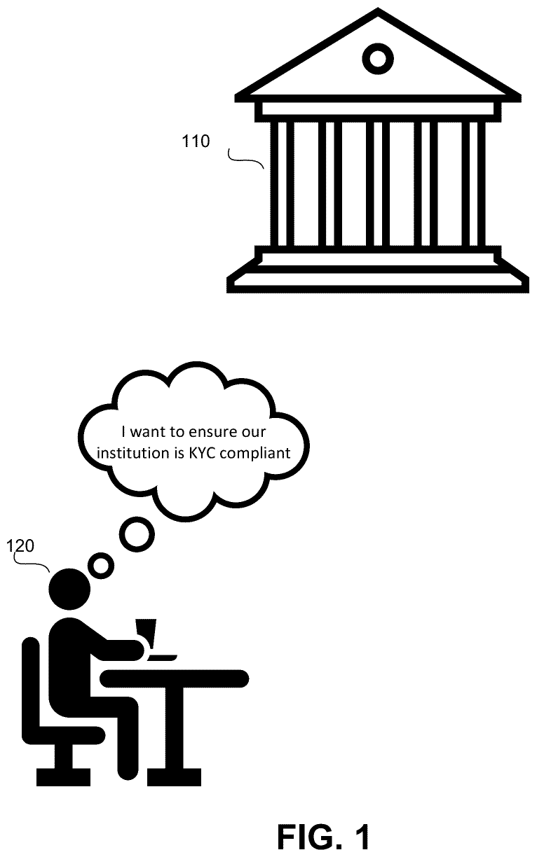

FIG. 1 illustrates an exemplary application of a KYC process, consistent with disclosed embodiments. As illustrated in FIG. 1, entity 110, which may be an individual, a financial institution, or an organization may need to ensure it is KYC compliant. Person 120, which also may be an individual, such as an individual who works for an entity, such as entity 110. As illustrated in FIG. 1, individual 120 may wish to ensure that entity 110 is KYC compliant. The systems and methods disclosed herein may sure that the KYC processing are performed securely, while also allowing entities 110 and 120 to ensure that the process is compliant with their specific needs. While FIG. 1 only illustrates one person 120 and one entity 110, the disclosed systems and methods may be applicable to any number of persons 120, entities 110, or any other persons or entities consistent with the present disclosure.

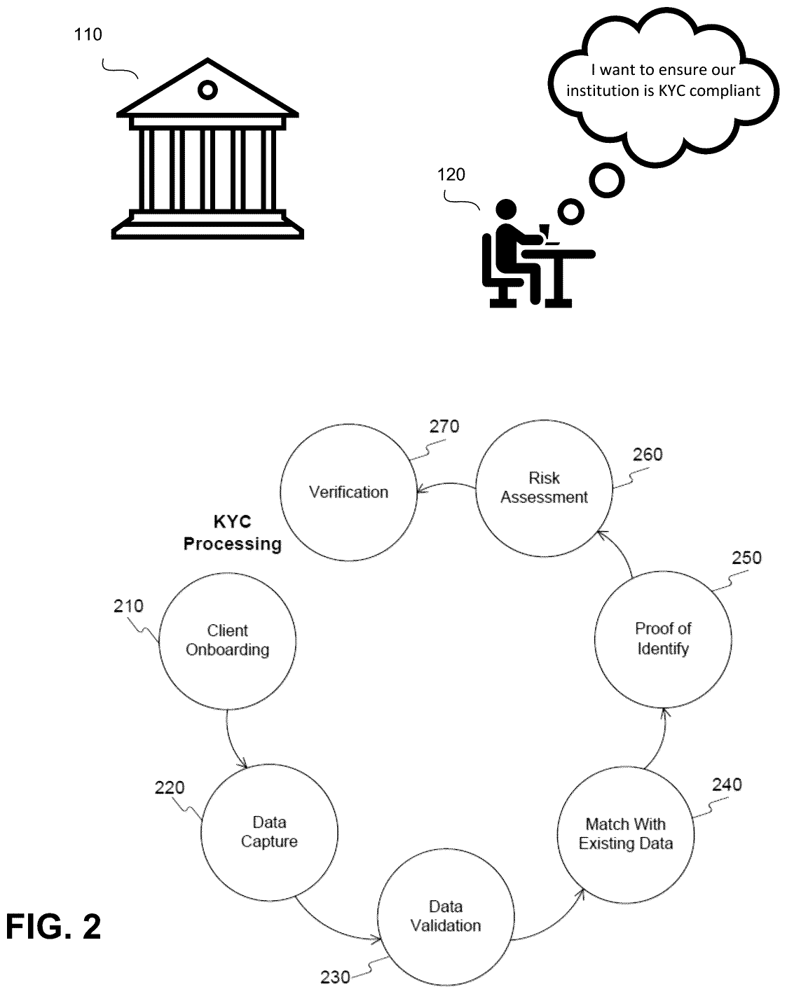

FIG. 2 illustrates an example flow environment for performing KYC validation, consistent with the disclosed embodiments. As shown in FIG. 2, there may be a KYC processing system to implement the KYC compliance needs illustrated in FIG. 1.

As illustrated in FIG. 2, the KYC processing process may comprise a variety of steps. These steps may be performed in the order illustrated in FIG. 2 or may be performed in a different order. The embodiment shown in FIG. 2 is merely illustrative. At client onboarding step 210, a client may be onboarded. In some embodiments, this may be an existing client. In other embodiments, this may be a new client. KYC onboarding for a client may verify the identification and information of a bank's customers. Customers may provide papers and information for verification before opening an account or verify their information for those who already have accounts.

At data capture step 220, the data from the papers and information provided at client onboarding 210 may be captured. In some embodiments, this may be a digital capture of information to automatically fill the required information for the KYC process.

At data validation step 230, the information provided may be validated against a database of information to confirm a customer's identity.

At match with existing data step 240, if the customer is an existing customer, the data may be matched with data that the financial institution already has.

At proof of identity step 250, the documents provided may be validated to confirm that a customer's identity matches the identity provided on the documentation.

At risk assessment step 260, a risk assessment for a customer may be performed. In some embodiments, this may be a standardized technique for determining the risk level a customer poses. Risk assessment may consider factors such as a risk posed for money laundering, if a customer is financing terrorism, if there is a close relative who is politically active, if a customer is sanctioned, or if a customer appears on a watchlist, as described previously. Risk assessment may also include looking at the geographic region of the customer or the types of services a customer may need.

At verification step 270, the KYC process may be verified and a customer may be approved. In some embodiments, periodic review may still occur from time to time to ensure the verification is valid.

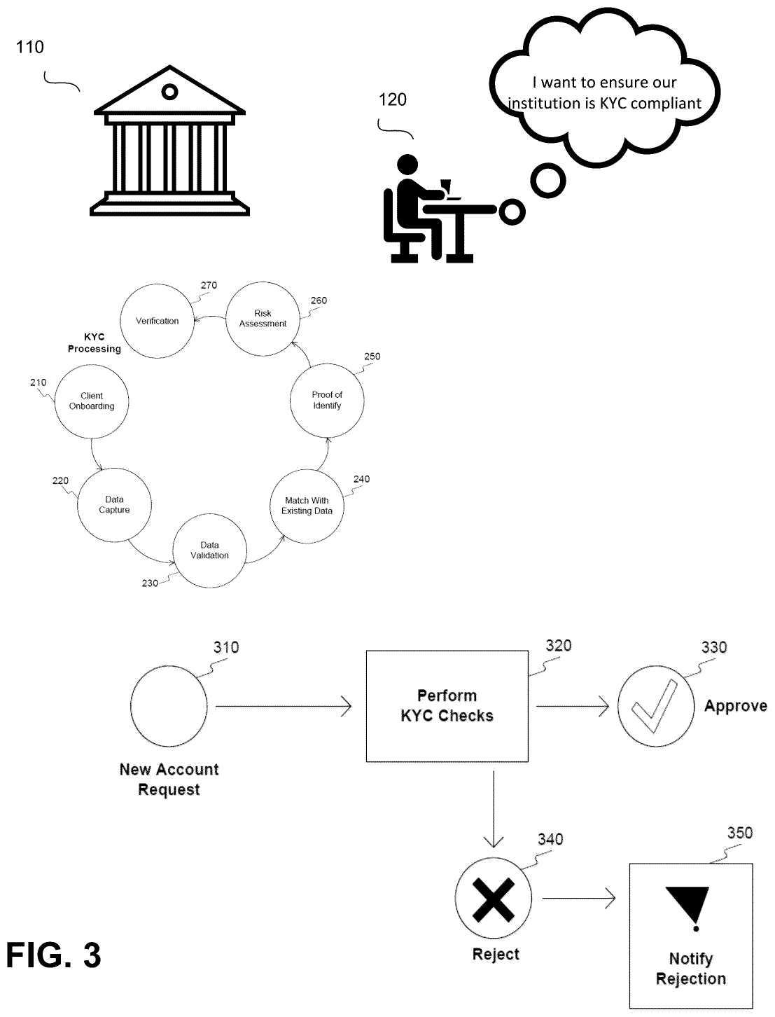

FIG. 3 illustrates an example flow diagram for KYC processing, consistent with the disclosed embodiments. As illustrated in FIG. 3, the elements from FIG. 1 and FIG. 2 for KYC compliance and KYC processing may be incorporated into the environment for KYC. As illustrated in FIG. 3, at new account request step 310, a new account request for KYC processing and verification may be initiated. At perform KYC checks step 320, the processing and verification checks may be performed, consistent with the disclosed embodiments. The KYC checks may result in approval (at approve step 330) or rejection (at reject step 340) of the new account request, consistent with disclosed embodiments. If the KYC process is rejected (at reject 340), there may be a notify rejection step 650 to notify the user that the process was not approved.

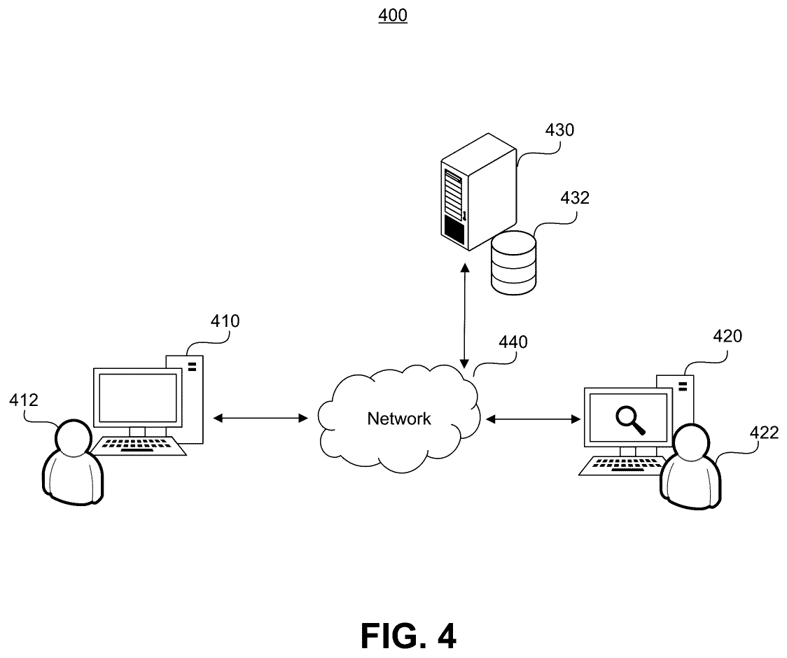

FIG. 4 is a diagram of an exemplary system environment 400 for performing a KYC process, consistent with disclosed embodiments. System environment 400 may include one or more financial institution endpoint devices 410, one or more customer endpoint devices 420, one or more computing devices 430, and one or more databases 432, as shown in FIG. 4.

The various components of system 400 may communicate over a network 440. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 400 is shown as a network-based environment, it is understood that in some embodiments, one or more aspects of the disclosed systems and methods may also be used in a localized system, with one or more of the components communicating directly with each other.

Customer endpoint devices 420 may be configured such that customer 422 may access a protected navigation location through a browser or other software executing on customer endpoint device 420. As used herein, a protected navigation location may be any network location deemed sensitive, e.g., a network location containing customer identification information. A protected navigation location may also refer to having one or more security protocols to authenticate a user trying to access the location. Activity of a user at the network location may be audited to provide increased accountability for the user. For example, a protected navigation location may include a particular URL (or URL domain, etc.), a network location internal to an organization, or any other sensitive network location. Customer endpoint device 420 may include any form of computer-based device or entity through which customer 422 may access a protected navigation location. For example, customer endpoint device 420 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may be capable of accessing web pages or other network locations. In some embodiments, customer endpoint device 420 may be a virtual machine (e.g., based on AWS™, Azure™, IBM Cloud™, etc.), container instance (e.g., Docker™ container, Java™ container, Windows Server™ container, etc.), or other virtualized instance. Using the disclosed methods, activity of customer 422 through customer endpoint device 420 may be monitored and recorded by a browser extension executing on customer endpoint device 420.

Customer endpoint device 420 may communicate with computing device 430 through network 440. For example, customer endpoint device 420 may receive a web link to enter KYC information and transmit data inputted by customer 422 to computing device 430. Customer endpoint device 420 may also authenticate an identity of customer 422 via a web link provided by computing device 430.

Computing device 430 may include any form of remote computing device configured to receive, store, and transmit data. For example, computing device 430 may be a server configured to store files accessible through a network (e.g., a web server, application server, virtualized server, etc.). Computing device 430 may interact with a database 432, for example, a customer KYC database, to receive and/or store information. Database 432 may be included on a volatile or non-volatile, magnetic, semiconductor, tape, optical, removable, non-removable, or other type of storage device or tangible or non-transitory computer-readable medium. Database 432 may also be part of computing device 430 or separate from computing device 430. When database 432 is not part of computing device 430, computing device 430 may exchange data with database 432 via a communication link. Database 432 may include one or more memory devices that store data and instructions used to perform one or more features of the disclosed embodiments. Database 432 may include any suitable databases, ranging from small databases hosted on a work station to large databases distributed among data centers. Database 432 may also include any combination of one or more databases controlled by memory controller devices (e.g., server(s), etc.) or software. For example, database 432 may include document management systems, Microsoft SQL™ databases, SharePoint™ databases, Oracle™ databases, Sybase™ databases, other relational databases, or non-relational databases, such as mongo and others. Although one database 432 is shown in FIG. 4, the system environment 400 may include one or more databases 432, which may be used to store various types of information associated with customers of a financial institution.

Financial institution endpoint device 410 may similarly communicate with computing device 430 through network 440. For example, financial institution endpoint device 410 may send a request to the computing device 430 to initiate a KYC process with a customer. Financial institution endpoint device 410 may also present collected KYC information to user 412 of the financial institution and request update of KYC information to computing device 430.

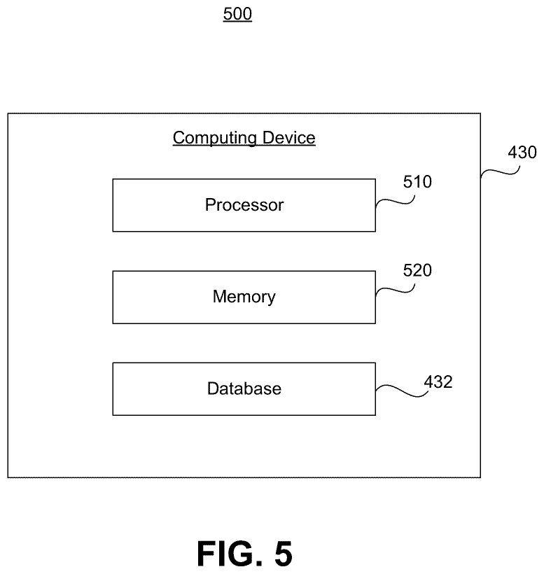

FIG. 5 is block diagram showing an example computing device 430, consistent with the disclosed embodiments. As described above, computing device 430 may be one or more devices configured to allow data to be received and/or transmitted by system 400 (e.g., a server, etc.) and may include one or more dedicated processors and/or memories. For example, computing device 430 may include a processor (or multiple processors) 510, and a memory (or multiple memories) 520, as shown in FIG. 5. Computing device 430 may include one or more digital and/or analog devices that may allow computing device 430 to communicate with other machines and devices, such as other components of system 400. Computing device 430 may include one or more input/output devices. Computing device 430 may include a screen for displaying communications to a user. In some embodiments computing device 430 may include a touch screen. Computing device 430 may include other components known in the art for interacting with a user. Computing device 430 may also include one or more digital and/or analog devices that may allow a user to interact with system 400, such as touch-sensitive area, keyboard, buttons, or microphones.

Processor 510 may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Furthermore, according to some embodiments, processor 510 may be from the family of processors manufactured by Intel®, AMD®, Qualcomm®, Apple®, NVIDIA®, or the like. The processor 510 may also be based on the ARM architecture, a mobile processor, or a graphics processing unit, etc. The disclosed embodiments are not limited to any type of processor configured in computing device 430. In some embodiments, processor 510 may be a special purpose processor configured to perform one or more of the operations described below.

Memory 520 may include one or more storage devices configured to store instructions used by the processor 510 to perform functions related to computing device 430. The disclosed embodiments are not limited to particular software programs or devices configured to perform dedicated tasks. For example, the memory 520 may store a single program, such as a user-level application, that performs the functions associated with the disclosed embodiments, or may comprise multiple software programs. Additionally, the processor 510 may, in some embodiments, execute one or more programs (or portions thereof) remotely located from computing device 430. Furthermore, memory 520 may include one or more storage devices configured to store data for use by the programs. Memory 520 may include, but is not limited to a hard drive, a solid state drive, a CD-ROM drive, a peripheral storage device (e.g., an external hard drive, a USB drive, etc.), a network drive, a cloud storage device, or any other storage device.

Computing device 430 may include a database 432 as described above. Database 432 may also be part of computing device 430 or separate from computing device 430. In some embodiments, computing device 430 may include one or more input/output devices, communications devices, displays, and/or other interfaces (e.g., server-to-server, database to-to-database, or other network connections). One or more of financial institution endpoint devices 410 and/or customer endpoint devices 420 may include components similar to those discussed with respect to computing device 430 and may perform functions similar to or different from those described above with respect to computing device 430.

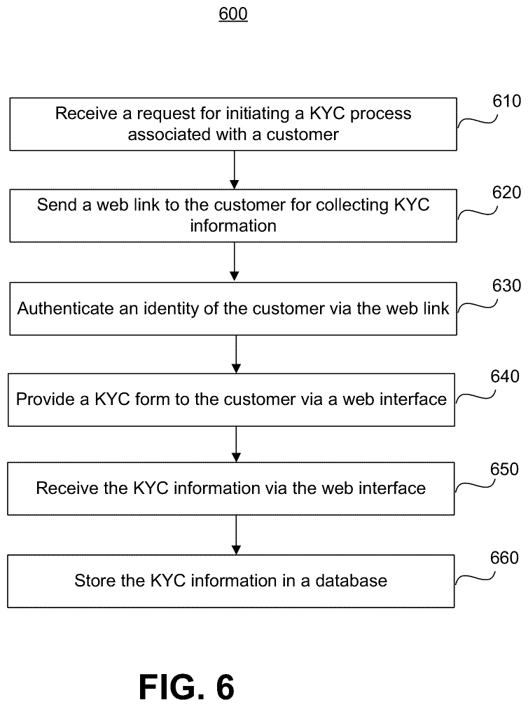

FIG. 6 is a flowchart of an exemplary method 600 for performing a KYC process, according to some embodiments. Method 600 may be performed by at least one processing device of a computing device, such as processor 510, as described above. In some embodiments, a non-transitory computer-readable medium may contain instructions that when executed by a processor cause the processor to perform method 600. Further, method 600 is not necessarily limited to the steps shown in FIG. 6.

In step 610, method 600 may include receiving, by a processor, a request for initiating a Know Your Customer (KYC) process associated with a customer. For example, the request may be sent by a user (e.g., an employee of a financial institution) via financial institution endpoint device 410. In other embodiments, the request may be initiated through a web link that a user receives through an email. The request for initiating a KYC process may include a name of the customer and a name of the contact person associated with the customer for providing the KYC information. In some embodiments, the request for initiating a KYC process may be a process for obtaining the KYC information that is not currently present in a KYC database. In other embodiments, the request for initiating a KYC process may be a process for obtaining updated KYC information while some KYC information associated with the customer is available in the KYC database. For example, if the existing KYC information was entered in the database prior to a predetermined time, it may be determined that a KYC process is needed to update the customer's KYC information. In some embodiments, the computing device may determine whether a customer's KYC information needs to be updated, and if so, send a message to the user reminding the user that the customer's KYC information is outdated and a KYC process is needed to update the customer's KYC information. In some embodiments, a customer may determine that the information is correct and does not need to be updated.

In some embodiments, the request may include a request to verify data related to a specific customer or user. Method 600 may be configured to verify one or more types of data. Data may include customer data, individual data, and the like. In some embodiments, the request may include verifying data in one or more languages or formats.

In some embodiments, the request may be made using an application programming interface (API). An API call may be a message sent to a server asking an API to provide a service or information. In some embodiments, a server, such as computing device 430 may receive the API call, process the API call, execute the request, and send a response.

In step 620, method 600 may include sending a web link to the customer for collecting KYC information associated with the customer. For example, the computing device may retrieve an email address of the contact person associated with the customer from a database and generate an email to the contact person. The computing device may also insert content in the email for collecting the KYC information. For example, the computing device may be configured to insert predetermined content from a template to the email. The computing device may generate a web link and insert it in the email. The web link may include a Uniform Resource Locator (URL) for directing an email recipient to a web page to provide requested KYC information. The computing device may further include an email of the user as a sender of the email and insert email addresses of other personnel (e.g., other employees in the financial institution) in the CC field of the email. After the computing device generates the email, the user may review the email via an endpoint device and make any desired changes.

In some embodiments, the user may be required to verify their information before they can review the email using one time password (OTP) authentication. One time password authentication may refer to an automatically generated numeric or alphanumeric string of characters that authenticates a user for a single transaction or login session. The OTP authentication may be used to replace authentication login information or may be used in addition to it to add another layer of security. An OTP is more secure than a static password because it is only used once and is not created by the user. The OTP may be implemented using hardware, software, or on demand. In some embodiments, an authentication manager on a network generates a number or shared secret using an OTP algorithm. The number and algorithm are then used to validate an OTP and in turn validate and authenticate a user.

Upon receiving a confirmation from the user, the computing device may send the email to the contact person. In some embodiments, the email may include instructions for accessing a website associated with the financial institution for providing the KYC information.

In step 630, method 600 may include authenticating an identity of the customer via the web link. For example, the computing device may perform a multi-factor authentication process via the web link. In the first step of the authentication process, the web link may direct the email recipient to a web page which requests the customer's account information, e.g., account number with the financial institution, email address of the contact person, identifier of the customer for accessing online account information, and the associated password for accessing the online account information. After the email recipient successfully completes the first step of the authentication process, the email recipient may be asked to enter a one-time password via a web interface as described above. The one-time password may be sent to a pre-stored email or phone number associated with the customer. Once the correct one-time password is received by the computing device, the email recipient is authenticated and method 600 may proceed to the next step. If the email recipient fails to authenticate in a predetermined time, the computing device may terminate the KYC process. In some embodiments, the computing device may notify the user of the failure of the authentication by the email recipient. Other types of authentication process may also be used without departing from the spirit of the present disclosure.

The authentication step may also include collection and analysis of basic identity information, name matching against lists of known parties, determining a customer's risk, and monitoring a customer's transactional behavior.

In step 640, method 600 may include providing a KYC form to the customer via a web interface. For example, the computing device may provide a KYC form including blank fields for the customer to fill in via a web interface. The KYC form may request disclosure of information including name of the customer, date of birth, and/or a government issued identification number (e.g., passport or drive license number) for an individual customer, political exposure, non-resident alien country of origin, non-resident alien ID type, and non-resident alien ID number. In some embodiments, political exposure may refer to persons that are required to identify their affiliation to a political person, such as a president of a country, the name of the politico (a politico may refer to a politician, delegate, or a person with influence in politics), the politico position, country of origin for the politico, and relationship to the politico. For a business customer, the KYC form may request disclosure of information including beneficial owner(s) of the business entity customer or individual(s) who own or control the business entity customer, entity name, entity type, tax identification information, and a physical address for the entity. The KYC form may include any other information required by the financial institution to verify an identity of the customer. In some embodiments, the computing device may obtain information about the customer from a database and auto-fill fields of the KYC form. For example, the computing device may obtain the name, account number, address of the customer from a customer database and auto-fill this information in the KYC form. In some embodiments, the KYC process may be a KYC refresh process, and the customer's KYC information may be available in the KYC database. In this instance, the computing device may retrieve the customer's existing KYC information from the database and auto-fill the information in the KYC form. The computing device may generate the KYC form in a format such that it can be displayed to the customer properly in the web interface. For example, the data may be presented in a user-interface friendly format.

The KYC information may be in compliance with the Federal Reserve Banks Anti-Money Laundering (AML) and KYC regulations. These regulations may require banks to collect controlling party and beneficial owner information for all legal entities that the bank provides services to.

In step 650, method 600 may include receiving the KYC information via the web interface. For example, the customer may review and revise the auto-filled information in the KYC form, and fill in additional information required by the KYC form, and submit the completed form to the computing device. In some embodiments, the computing device may check whether the submitted information is complete, and if one or more fields in the KYC form are missing, prompt the customer to complete the missing fields. The computing device may also check whether the submitted information matches the existing record in the customer database, and if the submitted information does not match with the existing record in the customer database, ask the customer to confirm the accuracy of the completed information. For example, if the date of the birth of the customer is different from the data of birth stored in the customer database, the computing device may provide a message for the discrepancy via the web interface and ask the customer to confirm the correct date of birth. In doing so, the customer may be prompted to provide correct KYC information if an error is present in the information completed in the KYC form.

The computing device may check the submitted information against a master data management (MDM) system that creates a single master record for each person in a business from across multiple data sources and applications. In some embodiments, if there is a conflict in the existing data in the MDM system and the data that a customer provides, there may be a flag to off ramp the customer into an off ramp process. In some embodiments, the off ramp process may compare critical data fields between what a customer submitted and what is logged in the MDM. For example, a critical data field may comprise a first name, a last name, a date of birth, or a social security number.

In some embodiments, if a customer has been flagged for the off ramp process, the customer may receive an email notification of the conflict. In some embodiments, the email notification may indicate which data point is the source of the conflict.

In some embodiments, to resolve an off ramp process issue, a customer must provide additional information to rectify the conflict. For example, if a last name does not match, and the customer recently changed their last name following a marriage, proof of a marriage license and name change may be submitted. In other embodiments, a customer may indicate that a typographical error was made to rectify the conflict.

In some embodiments, once the customer has given information to rectify the conflict, method 600 may begin from step 610 to perform the KYC process. In other embodiments, method 600 may perform step 650 again.

In some embodiments, once step 650 is performed again, system 400 may determine a risk rating for the new data provided by the customer. In some embodiments, the risk rating may be too high, based on a predetermined threshold for method 600 to continue, and the customer may be denied verification through the KYC process. The risk rating may be determined by a number of factors. For example, the risk rating may be determined based on country of residence, or type of business that is being conducted. Countries that present risk may be those sanctioned by the United States. Business conduct may include high-risk businesses, such as ownership of check cashing businesses or owning ATM's.

In some embodiments, some data entered at step 650 may raise a flag based on a red flag list. For example, system 400 may check address data entered and confirm that the address matches the address of a person on a watch list. This red flag may impact a customer's risk rating and may result in the customer being denied verification through the KYC process. In some embodiments, customer information may be checked against third party lists. For example, customer information may be checked against high-risk individuals, such as politically exposed persons or entities. These may include sanction lists (e.g. UN<EU, HMT, OFAC etc.), law enforcement lists, and financial and securities commissions lists.

In step 660, method 600 may include storing the received KYC information in a database, such as a KYC database. In some embodiments, the computing device may compare the received KYC information with the records stored in the KYC database, such as an MDM as described above. If no record for the customer is found in the KYC database, the computing device may store the received KYC information for the customer in the database as a new entry. If a record for the customer is found in the KYC database, the computing device may compare the existing record with the received KYC information and determine if there is any change from the existing record in the KYC database. If there is no change from the existing record in the KYC database, the computing device may update the KYC database to indicate that KYC information for the customer is confirmed at the date when the KYC information is received. In some implementations, the computing device may not initiate another KYC process with the customer until a predetermined period of time has passed since the date the KYC information was confirmed last time. If the computing device determines that the received KYC information is different from the existing record in the KYC database, the computing device may send a notification to a user of the KYC database alerting the change in the KYC information and requiring user input. If the computing device determines that the received KYC information matches multiple records in the KYC database, the computing device may send a message to a user of the KYC database alerting the duplicate KYC information and requiring user input to reconcile the information. The user input may comprise updating the data to reconcile the information. For example, if the computing device determines that the received KYC information contains a beneficial owner matching records of multiple customers in the KYC database, the computing device may send a notification to a user of the KYC database alerting the duplicate beneficial owner information and requiring user input.

As described above, the disclosed method 600 enables an automated process for collecting KYC information from a customer, eliminates the need for customers of financial institutions to fill out paper copies of KYC forms and return the paper forms by mail, and reduces human intervention and errors in inputting the information in the paper KYC forms returned by customers into the KYC database.

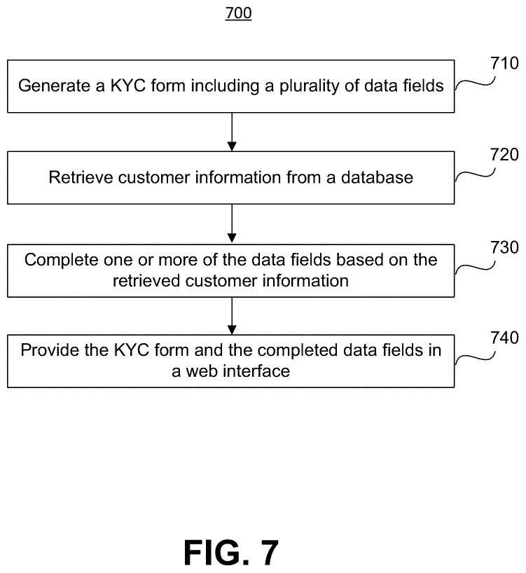

FIG. 7 is a flowchart of an exemplary method 700 for providing a KYC form, according to some embodiments. The method 700 may be performed by at least one processing device of a computing device, such as processor 520, as described above. The method 700 may be used to implement step 640 in method 600 as discussed above.

In step 710, method 700 may include generating a KYC form including a plurality of data fields. The computing device may generate the KYC form based on the type of customer. For example, for an individual customer, the KYC form may include data fields of customer name, address, phone number, date of birth, and so on. For a business customer, the KYC form may include data fields of business name of the customer, address, identity information of a beneficial owner who owns an interest in the customer, identity information of an individual completing the KYC form on behalf of the business customer, and so on.

In step 720, method 700 may include retrieving customer information from a database. For example, the computing device may check whether the KYC information for the customer is available in a KYC database, and retrieve the customer's KYC information if it is available. If no KYC information for the customer is available, the computing device may check one or more other customer databases and retrieve customer information such as name, address, phone number, and account number of the customer.

In step 730, method 700 may include completing one or more of the data fields based on the retrieved customer information. For example, the computing device may preload the customer's KYC information in the KYC form based on the retrieved customer information from the KYC database. If no KYC information for the customer is available, the computing device may complete fields of the KYC form based on available information of the customer. For example, the computing device may complete fields of the customer's name, address, and phone number based on retrieved customer contact information.

In step 740, method 700 may include providing the KYC form and the completed data fields in a web interface. For example, the computing device may transform the KYC form and data fields into a JavaScript Object Notation (JSON) format, so as to facilitate viewing of the form in the web interface. The computing device may provide the transformed KYC form and data fields to a customer via a network, such as network 440 as described above. The customer may use a customer device to view the KYC form and completed data fields, verify preloaded data fields, make changes, add additional required information, and submit the completed form to the computing device.

The web interface may comprise a welcome page to verify user information. The web interface may comprise a legal entity summary page that verifies user information such as name, taxpayer identification number, address, and a user type, such as an individual or a corporation. In some embodiments, a user may be able to edit the legal entity page to update an address or name. In some embodiments, a business registration address may not be used if it differs from the legal entity address. In some embodiments, a P.O. Box, store rental mailboxes, virtual or shared office space address may not be used. In some embodiments, once a user fills out information in the web interface, the information, such as address information will be verified against a database.

The web interface may also comprise a beneficial owners page. In some embodiments, the beneficial owners page may only apply to a corporation or entity, and not an individual. In some embodiments, a beneficial owner may refer to an individual who directly or indirectly owns 25% or more of the equity interests of the legal entity. In some embodiments, the beneficial owner information may comprise a name, address, and information to confirm citizenship, such as a social security card, passport, or diplomatic passport.

The web interface may also comprise a controlling party form. A controlling party may be an individual with responsibility for managing the legal entity, such as an executive officer or senior manager, or an individual who performs similar functions. In some embodiments, citizenship information may be required.

In some embodiments, the web interface also comprises a signature page requiring a digital signature. In some embodiment, upon completion, system 400 may send records to the user confirming a completed form.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as IOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file system, networking, I/O services, and provide a user interface functionality, such as a graphical user interface (“GUI”), among other things.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as example only, with a true scope and spirit being indicated by the following claims and their full scope of equivalents.

1.-20. (canceled)

21. A system comprising:
a memory storing a set of instructions; and
a processor configured to execute the set of instructions to perform operations including:
receiving an authentication request associated with a risk assessment validation request from a user device;
responsive to receiving the authentication request, sending a temporary authentication token to the user device through a network, the temporary authentication token being associated with a single login session;
receiving a responsive string associated with the authentication request from the user device;
validating the responsive string against the temporary authentication token;
responsive to validating the responsive string against the temporary authentication token, sending a temporary web link to the user device through the network, the temporary web link being associated with the single login session and being configured to:
request one or more customer account information elements;
request an authentication key associated with the one or more customer account information elements;
request one or more customer identity information elements;
request one or more stored user information elements from a database;
validate the one or more customer account information elements, the authentication key, and the customer identity information elements against the one or more stored user information elements;
responsive to the validation, obtain one or more user demographic fields from the database;
display the one or more user demographic fields on a graphical user interface;
receive a request to update at least one of the one or more user demographic fields with updated user demographic information; and
send the updated user demographic information to the database to be stored;
determining a risk rating based on the updated user demographic information; and
resolving the risk assessment validation request based on the risk rating.

22. The system of claim 21, wherein the instructions further include:
validating the one or more user demographic fields and the updated user demographic information using a master data management system.

23. The system of claim 22, wherein the master data management system is configured to:
flag the updated user demographic information as requiring an additional identity verification information element based on a conflict between the updated user demographic information and the one or more user demographic fields; and
the temporary web link is further configured to request the additional identity verification information element through the graphical user interface.

24. The system of claim 22, wherein the master data management system is configured to:
flag the updated user demographic information as requiring a corrected user demographic information element based on a conflict between the updated user demographic information and the one or more user demographic fields; and
the temporary web link is further configured to request the corrected user demographic information element through the graphical user interface.

25. The system of claim 21, wherein the risk rating is a high risk rating and the instructions further include:
denying the risk assessment validation request based on the high risk rating.

26. The system of claim 21, wherein the operations further include:
comparing the updated user demographic information to a high-risk information dataset.

27. The system of claim 26, wherein the operations further include:
denying the risk assessment validation request based on the comparison between the updated user demographic information to the high-risk information dataset resulting in a determination that the updated user demographic information is listed in the high-risk information dataset.

28. A non-transitory computer-readable medium storing a set of instructions that, when executed by one or more processors of a computing system, cause the computing system to:
receive an authentication request associated with a risk assessment validation request from a user device;
responsive to receiving the authentication request, send a temporary authentication token to the user device through a network, the temporary authentication token being associated with a single login session;
receive a responsive string associated with the authentication request from the user device;
validate the responsive string against the temporary authentication token;
responsive to validating the responsive string against the temporary authentication token, send a temporary web link to the user device through the network, the temporary web link being associated with the single login session and being configured to:
request one or more customer account information elements;
request an authentication key associated with the one or more customer account information elements;
request one or more customer identity information elements;
request one or more stored user information elements from a database;
validate the one or more customer account information elements, the authentication key, and the customer identity information elements against the one or more stored user information elements;
responsive to the validation, obtain one or more user demographic fields from the database;
display the one or more user demographic fields on a graphical user interface;
receive a request to update at least one of the one or more user demographic fields with updated user demographic information; and
send the updated user demographic information to the database to be stored;
determine a risk rating based on the updated user demographic information; and
resolve the risk assessment validation request based on the risk rating.

29. The non-transitory computer-readable medium of claim 28, wherein the instructions further cause the computing system to:
validate the one or more user demographic fields and the updated user demographic information using a master data management system.

30. The non-transitory computer-readable medium of claim 29, wherein the master data management system is configured to:
flag the updated user demographic information as requiring an additional identity verification information element based on a conflict between the updated user demographic information and the one or more user demographic fields; and
the temporary web link is further configured to request the additional identity verification information element through the graphical user interface.

31. The non-transitory computer-readable medium of claim 29, wherein the master data management system is configured to:
flag the updated user demographic information as requiring a corrected user demographic information element based on a conflict between the updated user demographic information and the one or more user demographic fields; and
the temporary web link is further configured to request the corrected user demographic information element through the graphical user interface.

32. The non-transitory computer-readable medium of claim 28, wherein the risk rating is a high risk rating and the instructions further cause the computing system to:
deny the risk assessment validation request based on the high risk rating.

33. The non-transitory computer-readable medium of claim 28, wherein the instructions further cause the computing system to:
compare the updated user demographic information to a high-risk information dataset.

34. The non-transitory computer-readable medium of claim 33, wherein the instructions further cause the computing system to:
deny the risk assessment validation request based on the comparison between the updated user demographic information to the high-risk information dataset resulting in a determination that the updated user demographic information is listed in the high-risk information dataset.

35. A method comprising the steps of:
receiving an authentication request associated with a risk assessment validation request from a user device;
responsive to receiving the authentication request, sending a temporary authentication token to the user device through a network, the temporary authentication token being associated with a single login session;
receiving a responsive string associated with the authentication request from the user device;
validating the responsive string against the temporary authentication token;
responsive to validating the responsive string against the temporary authentication token, sending a temporary web link to the user device through the network, the temporary web link being associated with the single login session and being configured to:
request one or more customer account information elements;
request an authentication key associated with the one or more customer account information elements;
request one or more customer identity information elements;
request one or more stored user information elements from a database;
validate the one or more customer account information elements, the authentication key, and the customer identity information elements against the one or more stored user information elements;
responsive to the validation, obtain one or more user demographic fields from the database;
display the one or more user demographic fields on a graphical user interface;
receive a request to update at least one of the one or more user demographic fields with updated user demographic information; and
send the updated user demographic information to the database to be stored;
determining a risk rating based on the updated user demographic information;
comparing the updated user demographic information to a high-risk information dataset; and
resolving the risk assessment validation request based on the risk rating and the comparison of the updated user demographic information to the high-risk information dataset.

36. The method of claim 35, further comprising:
validating the one or more user demographic fields and the updated user demographic information using a master data management system.

37. The method of claim 36, wherein the master data management system is configured to:
flag the updated user demographic information as requiring an additional identity verification information element based on a conflict between the updated user demographic information and the one or more user demographic fields; and
the temporary web link is further configured to request the additional identity verification information element through the graphical user interface.

38. The method of claim 36, wherein the master data management system is configured to:
flag the updated user demographic information as requiring a corrected user demographic information element based on a conflict between the updated user demographic information and the one or more user demographic fields; and
the temporary web link is further configured to request the corrected user demographic information element through the graphical user interface.

39. The method of claim 35, wherein the risk rating is a high risk rating and the method further comprises:
denying the risk assessment validation request based on the high risk rating.

40. The method of claim 35, further comprising:
denying the risk assessment validation request based on the comparison between the updated user demographic information to the high-risk information dataset resulting in a determination that the updated user demographic information is listed in the high-risk information dataset.
